(19) United States
(12) Patent Application Publication
(10) Pub. No.: US 2026/0176531 A1
(43) Pub. Date: Jun. 25, 2026

(54) CORROSION INHIBITOR HAVING SILICA NANOPARTICLES

(71) Applicant: ChampionX LLC, Sugar Land, TX (US)

(72) Inventors: Jeremy Moloney, Katy, TX (US); Duy Nguyen, Richmond, TX (US)

(21) Appl. No.: 19/538,410

(22) Filed: Feb. 12, 2026

Related U.S. Application Data
(63) Continuation of application No. 18/533,549, filed on Dec. 8, 2023.
(60) Provisional application No. 63/386,716, filed on Dec. 9, 2022.

(51) Int. Cl. C09K 15/30; C09K 8/54; C09K 15/02; C09K 15/12; C09K 15/16; C23F 11/14

(52) U.S. Cl. CPC C09K 15/30; C09K 8/54; C09K 15/02; C09K 15/12; C09K 15/16; C23F 11/149

(57) ABSTRACT

Corrosion inhibitor compositions that include silica nanoparticles. The silica nanoparticles can be functionalized with an organosilane. A method includes introducing, adding, or injecting the corrosion inhibitor composition into a fluid to inhibit corrosion on a metal surface that is in contact with the fluid.

### CROSS-REFERENCE TO RELATED APPLICATIONS

This application is a continuation of U.S. Nonprovisional patent application Ser. No. 18/533,549, filed on Dec. 8, 2023, which claims the benefit of and priority to U.S. Provisional Patent Application No. 63/386,716, filed on Dec. 9, 2022, and entitled “Corrosion Inhibitor Having Silica Nanoparticles,” each of which is incorporated by reference in its entirety.

### FIELD OF THE DISCLOSURE

The present disclosure generally relates to corrosion inhibitors, and more particularly to corrosion inhibitors that include silica nanoparticles.

### BACKGROUND

Oil and gas production infrastructure can include equipment (e.g., pipelines, flow lines, valves, separation equipment) that is constructed of mild carbon steel. The internal metal surfaces of the equipment are subject to corrosion, particularly for production fluid that has a high concentration of water and/or corrosive agents. Contact of the internal metal surfaces with water and/or corrosive agents can lead to corrosion, and even equipment failure. The rate of corrosion deterioration in oil and gas field equipment can depend upon production parameters such as oil/water ratio, brine composition, temperature, pH, and the concentration of corrosive agents that are present in the subterranean formation, such as CO₂ and H₂S.

In order to preserve the integrity of oil and gas infrastructure, corrosion inhibitors can be added into the production fluid upstream of the equipment that is to be protected. For example, corrosion inhibitors can protect the metal surface of pipeline and/or equipment through formation of a passivation film on the metal surface. This passivation layer oil wets the metal surface, which in turn prevents contact of the metal surface from the corrosive agents in the produced fluids.

Despite the availability of corrosion inhibitor formulations, there is ongoing effort to find improved compounds, compositions, and methods.

### SUMMARY

Disclosed are methods of inhibiting corrosion at a metal surface. One method can include contacting a fluid including a corrosion inhibitor composition as disclosed herein with a metal surface.

A corrosion inhibitor composition can include: silica nanoparticles, an imidazoline derivative, a nonionic surfactant, an oligomeric fatty acid, an emulsion breaker, and a solvent. The silica nanoparticles can be non-functionalized, functionalized (surface-modified), or contain a first portion of non-functionalized silica nanoparticles and a second portion of functionalized silica nanoparticles. The silica nanoparticles can be present in an amount of from about 0.1 wt % to about 1 wt % based on a total weight of the corrosion inhibitor composition.

A fluid can include the corrosion inhibitor composition; and water, a hydrocarbon, or a combination thereof. The corrosion inhibitor composition is present in an amount of from 1 ppm to 100,000 ppm based on a total weight of the fluid

Other technical features may be readily apparent to one skilled in the art from the following FIGURES, descriptions and claims.

### DETAILED DESCRIPTION

The term “alkyl,” as used herein, refers to a linear or branched hydrocarbon radical, preferably having 1 to 32 carbon atoms (i.e., 1, 2, 3, 4, 5, 6, 7, 8, 9, 10, 11, 12, 13, 14, 15, 16, 17, 18, 19, 20, 21, 22, 23, 24, 25, 26, 27, 28, 39, 30, 31, or 32 carbons). Alkyl groups include, but are not limited to, methyl, ethyl, n-propyl, isopropyl, n-butyl, iso-butyl, secondary-butyl, and tertiary-butyl. Alkyl groups may be unsubstituted or substituted by one or more suitable substituents, as defined above.

The term “aryl,” as used herein, means monocyclic, bicyclic, or tricyclic aromatic radicals such as phenyl, naphthyl, tetrahydronaphthyl, indanyl and the like; optionally substituted by one or more suitable substituents, preferably 1 to 5 suitable substituents, as defined above.

The term “arylalkyl,” as used herein, refers to an aryl group attached to the parent molecular moiety through an alkyl group. Arylalkyl groups may be unsubstituted or substituted by one or more suitable substituents, as defined above.

The term “alkoxy,” as used herein, refers to an alkyl group, as defined herein, appended to the parent molecular moiety through an oxygen atom.

The term “hydroxy,” as used herein, refers to an —OH group.

The term “low total dissolved solids,” as used herein, refers to a range of from 1 wt % to less than 15 wt % total dissolved solids in a fluid, based on a total weight of a fluid.

The term “high total dissolved solids,” as used herein, refers to a range of equal to or greater than 15 wt % total dissolved solids in a fluid, based on a total weight of a fluid.

The term “chemical bond” as used herein refers to ionic bonds and covalent bonds formed between atoms of a molecule. As used herein, “chemical bond” is distinguishable from a complex formed by attractive forces between atoms, such as electrostatic interaction and van der Waals forces, that can be present in a complex without any chemical bonds formed between the different chemical species of the complex.

As used herein, any recited ranges of values contemplate all values within the range including the end points of the range, and are to be construed as support for claims reciting any sub-ranges having endpoints which are real number values within the recited range. By way of example, a disclosure in this specification of a range of from 10 to 15 shall be considered to support claims to values of 10, 11, 12, 13, 14, and 15, and to any of the following ranges: 10-11, 10-12, 10-13, 10-14, 10-15, 11-12, 11-13, 11-14, 11-15, 12-13; 12-14, 12-15, 13-14, 13-15, and 14-15.

Disclosed herein are corrosion inhibitor compositions and methods. The corrosion inhibitor compositions generally include silica nanoparticles (functionalized or non-functionalized), a quaternary ammonium compound, an imidazoline derivative, and an organic sulfur compound. The compositions can additionally include any additional component described herein.

Incorporation of silica nanoparticles into the disclosed corrosion inhibitor compositions is useful in both in low total dissolved solids (TDS) fluids and high TDS fluids. It has been found that corrosion inhibition performance increases when silica nanoparticles are added to form the disclosed corrosion inhibitor compositions. It is believed that strong electrostatic interaction, Van der Waals forces, or both, between the silica nanoparticles and other corrosion inhibitor composition components (e.g., a quaternary ammonium compound, an imidazoline derivative, an organic sulfur compound, or combinations thereof) form complexes between silica nanoparticles and the components (e.g., the quaternary ammonium compound(s), the imidazoline derivative(s), the organic sulfur compound(s), or combinations thereof), increasing corrosion inhibition performance. In low TDS fluids, silica non-functionalized nanoparticles can form complexes and remain in solution without precipitating out of the fluid. In high TDS fluids, silica nanoparticle complexes can precipitate out of the fluid; however, silica nanoparticles that are functionalized, or surface-modified, as described herein can form complexes and remain in solution without precipitating out of the high TDS fluid. When referring to a “complex” or “complexes” between the silica nanoparticles and another corrosion inhibitor composition component, it is meant that the silica nanoparticles do not form a chemical bond with any of the other corrosion inhibitor composition components. In aspects, the silica nanoparticles do not form a chemical bond with the quaternary ammonium compound, the imidazoline derivative, the organic sulfur compound, or combinations thereof. In aspects, the silica nanoparticles do not form a chemical bond with the quaternary ammonium compound(s), the silica nanoparticles do not form a chemical bond with the imidazoline derivative(s), and the silica nanoparticles do not form a chemical bond with the organic sulfur compound(s). A chemical bond is not formed because there is no chemical reaction between the silica nanoparticles and any of the corrosion inhibitor components. Instead, the electrostatic interaction, van der Waals forces, or both, provide attractive forces between the silica nanoparticles and the other corrosion inhibitor components to form one or more complexes, without forming a chemical bond.

### Silica Nanoparticles

Silica nanoparticles as disclosed herein are solid silica particles that have at least one dimension that is from 1 nm to 400 nm; alternatively, 1 nm to 300 nm; alternatively, 1 nm to 250 nm; alternatively, 1 nm to 100 nm; alternatively, 200 nm to 500 nm; alternatively, 200 nm to 400 nm; alternatively, 300 nm to 400 nm; alternatively, from 30 nm to 100 nm; alternatively, from 50 nm to 100 nm; alternatively, from 1 nm to 50 nm; alternatively, from 1 nm to 40 nm; alternatively, from 1 nm to 30 nm. The silica nanoparticles may assume a variety of geometries, such as spheres, hollow shells, rods, plates, ribbons, prisms, stars, or combinations thereof. All geometries of nanoparticles are understood to be within the scope of this disclosure. For example, a silica particle of 2 μm length and 10 nm diameter would be considered a “silica nanoparticle” even though one of its dimensions is larger than the largest dimension generally accepted for nanoparticles, i.e., 500 nm. In another example, a silica rod of 10 nm diameter and 5 μm length would be considered a nanoparticle (a rod-like nanoparticle, or nanorod).

In aspects, the at least one dimension is a diameter or approximate diameter of the silica nanoparticles. The size of the silica nanoparticles can be obtained by measuring the diameter or approximate diameter. For a population of nanoparticles, the diameter or approximate diameter can also be referred to as a Z-average particle size, which can be measured according to routine protocols known to one skilled in the art, for example, dynamic light scattering (DLS) (Z-average). Particle size can also be measured by Transmission Electron Microscopy (TEM).

In some aspects, the silica nanoparticles can be in the form of colloidal silica nanoparticles. Colloidal silica nanoparticles are produced and commercially available in dispersions (or sols for solid-liquid systems). In some aspects, the silica nanoparticles are present in a dispersion of colloidal silica particles. In these aspects, the dispersion can contain 1 wt % to 35 wt % colloidal silica and 65 wt % to 99 wt % aqueous solvent. In some embodiments, the aqueous solvent used for the dispersion is water.

In aspects, a surface area of the silica nanoparticles can be in a range of 100 to 500 m²/g; alternatively, 150 to 450 m²/g; alternatively, 200 to 400 m²/g; alternatively 250 to 350 m²/g.

Silica nanoparticles in aqueous media (sols) are available commercially. For example, aqueous or aqueous alcohol solutions of silica nanoparticles are commercially available under the tradenames LUDOX® from W.R. Grace & Co.-Conn., NYACOL® or NEXSIL® from NYACOL® Nano Technologies, Inc., or other sols from ECOLAB®. One useful silica sol with an average particle size of 7-9 nm, a nominal solids content of 30.11 wt %, and a surface area of 330 m²/g is available as NALCO 1130 from ECOLAB®.

### Surface Modified SNPs

In aspects, the silica nanoparticles in the corrosion inhibitor composition are functionalized, also referred to herein as surface-modified, silica nanoparticles. In aspects where silica nanoparticles are obtained as a colloidal silica dispersion, the colloidal silica can be functionalized (e.g., functional groups, such as organosilanes, attached, coupled, or bonded to the surface of the silica particles).

In aspects, the silica nanoparticles are functionalized with one or more surface-coupling agents. Surface-coupling agents can include one or more organosilane, one or more zwitterionic silane, or combinations thereof.

Organosilanes can include a silane, an aryl silane, an alkoxy silane, an alkyl silane, or combinations thereof. In some embodiments, the organosilane can have one or more epoxy groups, vinyl groups, ether groups, styryl groups, methacryl groups, acryl groups, amino groups, isocyanurate groups, or combinations thereof.

Examples of organosilanes include an alkoxysilane, a silazane, a siloxane, or combinations thereof.

Additional examples of organosilanes include 3-glycidoxypropyltrimethoxysilane, 3-glycidoxypropyltriethoxysilane, 3-glycidoxypropylmethyldimethoxysilane, 3-glycidoxypropylmethyldiethoxysilane, 3-glycidoxypropyltriethoxysilane, 2-(3,4-epoxycyclohexyl)propyltrimethoxysilane, 2-(3,4-epoxycyclohexyl)propyltriethoxysilane, 2-(3,4-epoxycyclohexyl)ethyltrimethoxysilane, 2-(3,4-epoxycyclohexyl)ethyltriethoxysilane, 2-(3,4-epoxycyclohexyl)methyltrimethoxysilane, 2-(3,4-epoxycyclohexyl)methyltriethoxysilane, [(3-ethyl-3-oxethanyl)methoxy]propyltrimethoxysilane, [(3-ethyl-3-oxethanyl)methoxy]propyltriethoxysilane, or combinations thereof.

Zwitterionic silanes can include a zwitterionic sulfonate functional silane, a zwitterionic carboxylate functional silane, a zwitterionic phosphate functional silane, a zwitterionic phosphonic acid functional silane, or combinations thereof. Examples of zwitterionic silanes include N,N-dimethyl,N-(2-ethyl phosphate ethyl)-aminopropyltri-methyoxysilane (DMPAMS), 3-(dimethyl(3-(trimethoxysilyl) propyl)-ammonio) propane-1-sulfonate, 3-(dimethyl (3-(triethoxysilyl) propyl)-ammonio) propane-1-sulfonate, 3-(diethyl (3-(trimethoxysilyl) propyl)-ammonio) propane-1-sulfonate, or combinations thereof.

In aspects, the surface-modified nanoparticles have at least one dimension that is from 1 nm to 500 nm; alternatively, from 1 nm to 400 nm; alternatively, from 1 nm to 250 nm; alternatively, from 1 nm to 100 nm; alternatively, from 10 nm to 50 nm; alternatively, from 200 nm to 500 nm; alternatively, from 200 nm to 400 nm; alternatively, from 300 nm to 400 nm.

In aspects, the mass ratio of the surface-coupling agent(s) to the silica nanoparticles (e.g. colloidal silica nanoparticles) is 0.1:15; alternatively, 0.1:10; alternatively, 0.1:5; alternatively, 0.01:5.

Techniques are known for attaching, coupling, or bonding functional groups to the silica nanoparticles to provide functionalized (or surface-modified) silica nanoparticles. See, e.g., Ralph K. Iler, The Chemistry of Silica: Solubility, Polymerization, Colloid and Surface Properties, and Biochemistry, Wiley-Interscience, NY, 1979; VanDerVoort, P. and Vansant, E. F., Journal of Liquid Chromatography and Related Technologies, 19:2723-2752, 1996; or Energy & Fuels 2017, 31, 2663-2668; Soft Matter, 2016, 12, 2025-2039; SPE-179576-MS presented at the SPE Improved Oil Recovery Conference, 11-13 Apr. 2016; SPE-186328-MS presented at the SPE/ATMI Asia Pacific Oil & Gas Conference and Exhibition, 17-19 Oct. 2017; Energy & Fuels 2018, 32, 287-293. For example, bonding surface-coupling agents to silica nanoparticle surfaces can include reacting a dispersion or solution of silica nanoparticles with one or more surface-coupling agents. In some embodiments, the nanoparticle concentration in the dispersion or solution is in a range of from about 0.01 wt % to about 30 wt % and the concentration of surface-coupling agents is that which is sufficient to react with SiOH present on the surface of the silica nanoparticles. The amount of surface-coupling agents reacted with the silica nanoparticles may be determined by the diameter and specific surface area of the silica nanoparticles. The medium for reaction comprises from 0 wt % to 100 wt % water, the balance (if any) being made up by an organic solvent such as ethanol, methanol, dimethylformamide (DMF), dimethyl sulfoxide (DMSO), 1,4 dioxane, tetrahydrofuran (THF), acetonitrile, acetone, n-butanol, isopropanol, n-propanol, or combinations thereof. If an organic solvent system is to be used, sufficient water must be present to promote the hydrolysis/condensation reactions that attach the zwitterion silane to the surface. The amount of water is typically in a range of from 1 ppm to 1 wt %.

In aspects, the corrosion inhibitor composition contains both non-functionalized silica nanoparticles and functionalized silica nanoparticles. In such aspects, the mass ratio of non-functionalized silica nanoparticles to functionalized silica nanoparticles can from 0.01:1 to 1:0.01 based on a total weight of the silica nanoparticles and functionalized silica nanoparticles.

### Quaternary Ammonium Compounds

Quaternary ammonium compounds can include, but are not limited to, tetramethyl ammonium chloride, tetraethyl ammonium chloride, tetrapropyl ammonium chloride, tetrabutyl ammonium chloride, tetrahexyl ammonium chloride, tetraoctyl ammonium chloride, benzyltimethyl ammonium chloride, benzyltriethyl ammonium chloride, phenyltrimethyl ammonium chloride, phenyltriethyl ammonium chloride, cetyl benzyldimethyl ammonium chloride, hexadecyl trimethyl ammonium chloride, dimethyl alkyl benzyl quaternary ammonium compounds, monomethyl dialkyl benzyl quaternary ammonium compounds, trimethyl benzyl quaternary ammonium compounds, trialkyl benzyl quaternary ammonium compounds, or combinations thereof. In compounds having one or more alkyl groups, the alkyl group can contain from about 6 to about 24 carbon atoms; alternatively, from about 10 to about 18 carbon atoms; alternatively, from about 12 to about 16 carbon atoms. Examples of quaternary ammonium compounds that are referred to as “quats” can include, but are not limited to, trialkyl-, dialkyl-, dialkoxy alkyl-, monoalkoxy-, benzyl-, and imidazolinium-quaternary ammonium compounds and salts thereof.

Examples of the quaternary ammonium compound that are salts include an alkylamine benzyl quaternary ammonium salt, a benzyl triethanolamine quaternary ammonium salt, a benzyl dimethylaminoethanolamine quaternary ammonium salt, or combinations thereof.

Additional examples of alkyl-, hydroxyalkyl-, alkylaryl-, arylalkyl-, and aryl-amine quaternary salts include those having the formula [N⁺R^{5a}R^{6a}R^{7a}R^{8a}][X⁻], wherein R^{5a}, R^{6a}, R^{7a}, and R^{8a} contain one to 18 carbon atoms, and X is Cl, Br or I. In certain embodiments, R^{5a}, R^{6a}, R^{7a}, and R^{8a} are each independently selected from the group consisting of alkyl (e.g., C₁-C₁₈ alkyl), hydroxyalkyl (e.g., C₁-C₁₈ hydroxyalkyl), and arylalkyl (e.g., benzylakyl). The mono or polycyclic aromatic amine salt with an alkyl or alkylaryl halide include salts of the formula [N⁺R^{5a}R^{6a}R^{7a}R^{8a}][X⁻] wherein R^{5a}, R^{6a}, R^{7a}, and R^{8a} contain one to 18 carbon atoms, and X is Cl, Br or I.

In aspects, the quaternary ammonium compound can be represented by the formula:

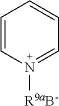

wherein R^{9a} is an alkyl group, an aryl group, or an arylalkyl group, wherein the alkyl groups have from 1 to about 18 carbon atoms and B is Cl, Br or I. Among these compounds are alkyl pyridinium salts and alkyl pyridinium benzyl quats. Examples include methylpyridinium chloride, ethyl pyridinium chloride, propyl pyridinium chloride, butyl pyridinium chloride, octyl pyridinium chloride, decyl pyridinium chloride, lauryl pyridinium chloride, cetyl pyridinium chloride, benzyl pyridinium and an alkyl benzyl pyridinium chloride, preferably wherein the alkyl group is a C₁-C₆ hydrocarbyl group. In certain embodiments, the quaternary ammonium compound includes benzyl pyridinium chloride.

### Imidazoline Derivative

In aspects, the imidazoline derivative can be selected from an imidazoline derived from a diamine and a long chain fatty acid. Examples of the diamine can include ethylene diamine (EDA), diethylene triamine (DETA), triethylene tetraamine (TETA), or combinations thereof. An example of the long chain fatty acid includes tall oil fatty acid (TOFA), which can be an alkyl mixture of C₁₆-C¹⁸ fatty acids. Suitable imidazolines include those of formula:

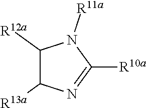

wherein R^{10a} is a C₁-C₂₀ alkyl group, a C₁-C₂₀ alkoxyalkyl group, or tall oil fatty acid; R^{11a} is hydrogen, a C₁-C₆ alkyl group, a C₁-C₆ hydroxyalkyl group, or a C₁-C₆ arylalkyl group; and R^{12a} and R^{13a} are independently selected from hydrogen or a C₁-C₆ alkyl group. In a particular embodiment, R^{10a} is the alkyl mixture of C₁₆-C₁₈ fatty acids in tall oil fatty acid (TOFA), and R^{11a}, R^{12a} and R^{13a} are each hydrogen.

### Organic Sulfur Compounds

Organic sulfur compounds can include a thiol (also known as a mercaptan), an organic disulfide, or combinations thereof. Examples of thiols include 2-mercaptoehtanol, mercaptoacetic acid, or combinations thereof. Examples of disulfide compounds have the following formula:

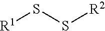

where R¹ and R² are each independently selected from a C₁-C₁₀-alkyl group, a C₁-C₁₀-alkenyl group, a C₂-C₁₀-alkynyl group, a C₆-C₁₂-aryl group, a monocyclic or bicyclic heteroaryl group, monocyclic or bicyclic heterocycle group, and C₃-C₈-cycloalkyl group, wherein each alkyl, alkenyl, alkynyl, aryl, heteroaryl, heterocycle, and cycloalkyl group is independently unsubstituted or substituted with 1 to 3 substituents independently selected from —F, —Cl, —NO₂, —CN, —OH, —NH₂, a C₁-C₆ alkyl group, a C₁-C₆ haloalkyl group, a C₁-C₆ alkoxy group, —CO₂R³, and —CON(R⁴)₂, wherein R³ and R⁴, at each occurrence, are each independently selected from hydrogen and a C₁-C₆ alkyl group. Other exemplary disulfide compounds are disclosed in U.S. Pat. No. 9,238,588 B2, which is incorporated by reference in its entirety.

### Concentrations

In aspects, the corrosion inhibitor composition can include i) silica nanoparticles in an amount of from about 0.1 wt % to about 99 wt %; alternatively, from about 0.1 wt % to about 10 wt %; alternatively, from about 0.1 wt % to about 9 wt %; alternatively, from about 0.1 wt % to about 8 wt %; alternatively, from about 0.1 wt % to about 7 wt %; alternatively, from about 0.1 wt % to about 6 wt %; alternatively, from about 0.1 wt % to about 5 wt %; alternatively, from about 0.1 wt % to about 4 wt %; from about 0.1 wt % to about 3 wt %; alternatively, from about 0.1 wt % to 2 wt %; alternatively, from about 0.1 wt % to about 1 wt %; alternatively, from about 1 wt % to about 2 wt %; alternatively, from about 1 wt % to about 3 wt %; alternatively, from about 2 wt % to about 3 wt %, based on a total sum weight of based on a total weight of the corrosion inhibitor composition. In aspects, the concentration of silica nanoparticles in the corrosion inhibitor composition can be 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, or 3.0 wt % based on a total weight of the corrosion inhibitor composition. The concentration of silica nanoparticles can be the concentration of i) non-functionalized silica nanoparticles for compositions having no functionalized silica nanoparticles, ii) functionalized silica nanoparticles for compositions having no non-functionalized silica nanoparticles, or iii) functionalized and non-functionalized silica nanoparticles for compositions having both functionalized silica nanoparticles and non-functionalized silica nanoparticles.

In aspects, the corrosion inhibitor composition can include one or more quaternary ammonium compounds, imidazoline derivatives, and organic sulfur compounds in an amount of from about 40 wt % to about 99 wt %; alternatively, from about 40 wt % to about 80 wt %; alternatively, from about 50 wt % to about 70 wt %; alternatively, from about 55 wt % to about 65 wt %, based on a total weight of the corrosion inhibitor composition.

In aspects, a weight ratio of the i) quaternary ammonium compound(s), imidazoline derivative(s), and organic sulfur compound(s) to the ii) silica nanoparticles, is in a range of from 1:1 to 1,000:1; alternatively, from 5:1 to 900:1; alternatively, from 10:1 to 800:1; alternatively, from 15:1 to 700:1; alternatively, from 20:1 to 650:1.

### Additional Components

Additional components for inclusion in the compositions include phosphate ester, monomeric or oligomeric fatty acids, solvents, asphaltene inhibitors, paraffin inhibitors, scale inhibitors, emulsifiers, water clarifiers, dispersants, emulsion breakers, hydrogen sulfide scavengers, gas hydrate inhibitors, biocides, pH modifiers, surfactants, functional agents and other additives, or combinations thereof.

### Phosphate Esters

In aspects, the corrosion inhibitor compositions disclosed herein can include mono-, di- or tri-alkyl or alkylaryl phosphate esters; phosphate esters of hydroxylamines; phosphate esters of polyols, or combinations thereof.

Suitable mono-, di- and tri-alkyl phosphate esters, mono-, di- and tri-alkylaryl phosphate esters, and phosphate esters of mono-, di-, and tri-ethanolamine typically contain from 1 to about 18 carbon atoms. In some aspects, the mono-, di- and trialkyl phosphate esters, mono-, di- and tri-alkylaryl phosphate esters, and mono-, di- and tri-arylalkyl phosphate esters are those prepared by reacting a C₃-C₁₈ aliphatic alcohol with phosphorous pentoxide. The phosphate intermediate interchanges its ester groups with triethyl phosphate with triethylphosphate producing a broader distribution of alkyl phosphate esters. Alternatively, the phosphate ester may be made by admixing with an alkyl diester, a mixture of low molecular weight alkyl alcohols or diols. The low molecular weight alkyl alcohols or diols preferably include C₆ to C₁₀ alcohols or diols. Further, phosphate esters of polyols and their salts containing one or more 2-hydroxyethyl groups, and hydroxylamine phosphate esters obtained by reacting polyphosphoric acid or phosphorus pentoxide with hydroxylamines such as diethanolamine or triethanolamine are preferred.

### Monomeric and Oligomeric Fatty Acid

The corrosion inhibitor composition can further include a monomeric or oligomeric fatty acid. Preferred are C₁₄-C₂₂ saturated and unsaturated fatty acids as well as dimer, trimer and oligomer products obtained by polymerizing one or more of such fatty acids.

### Solvents

The corrosion inhibitor composition can further include one or more solvents.

Examples of solvents include, but are not limited to, water, alcohols, hydrocarbons, ketones, ethers, aromatics, amides, nitriles, sulfoxides, esters, glycol ethers, aqueous systems, and combinations thereof. In certain embodiments, the solvent is water, isopropanol, methanol, ethanol, 2-ethylhexanol, heavy aromatic naphtha, toluene, ethylene glycol, ethylene glycol monobutyl ether (EGMBE), diethylene glycol monoethyl ether, xylene, or combinations thereof. Representative polar solvents suitable for formulation with the composition include water, brine, seawater, alcohols (including straight chain or branched aliphatic such as methanol, ethanol, propanol, isopropanol, butanol, 2-ethylhexanol, hexanol, octanol, decanol, 2-butoxyethanol, etc.), glycols and derivatives (ethylene glycol, 1,2-propylene glycol, 1,3-propylene glycol, ethylene glycol monobutyl ether, etc.), ketones (cyclohexanone, diisobutylketone), N-methylpyrrolidinone (NMP), N,N-dimethytformamide, or combinations thereof. Representative non-polar solvents suitable for formulation with the composition include aliphatic hydrocarbons such as pentane, hexane, cyclohexane, methylcyclohexane, heptane, decane, dodecane, diesel, or combinations thereof; aromatic hydrocarbons such as toluene, xylene, heavy aromatic naphtha, fatty acid derivatives (acids, esters, amides), or combinations thereof; or any combination of aliphatic hydrocarbons and aromatic hydrocarbons.

In certain embodiments, the solvent is a polyhydroxylated solvent, a polyether, an alcohol, or a combination thereof. In certain embodiments, the solvent is monoethyleneglycol, methanol, dimethyl sulfoxide (DMSO), dimethylformamide (DMF), tetrahydrofuran (THF), or a combination thereof.

A corrosion inhibitor composition may comprise from 0 wt % to 99 wt %; alternatively, from 1 wt % to 98 wt % of one or more solvents, based on total weight of the corrosion inhibitor composition. In certain embodiments, a corrosion inhibitor composition disclosed herein can include 20 wt %, 25 wt %, 30 wt %, 35 wt %, 40 wt %, 45 wt %, 50 wt %, 55 wt %, 60 wt %, 65 wt %, 70 wt %, 75 wt %, 80 wt %, 85 wt %, 90 wt %, or 95 wt % of one or more solvents, based on total weight of the corrosion inhibitor composition. In certain embodiments, a corrosion inhibitor composition comprises 80 wt %, 81 wt %, 82 wt %, 83 wt %, 84 wt %, 85 wt %, 86 wt %, 87 wt %, 88 wt %, 89 wt %, 90 wt %, 91 wt %, 92 wt %, 93 wt %, 94 wt %, 95 wt %, 96 wt %, 97 wt %, 98 wt %, or 99 wt % of one or more solvents, based on total weight of the corrosion inhibitor composition.

### Asphaltene Inhibitors

The corrosion inhibitor composition can additionally include an asphaltene inhibitor. Examples of asphaltene inhibitors include, but are not limited to, aliphatic sulphonic acids; alkyl aryl sulphonic acids; aryl sulfonates; lignosulfonates; alkylphenol/aldehyde resins and similar sulfonated resins; polyolefin esters; polyolefin imides; polyolefin esters with alkyl, alkylenephenyl or alkylenepyridyl functional groups; polyolefin amides; polyolefin amides with alkyl, alkylenephenyl or alkylenepyridyl functional groups; polyolefin imides with alkyl, alkylenephenyl or alkylenepyridyl functional groups; alkenyl/vinyl pyrrolidone copolymers; graft polymers of polyolefins with maleic anhydride or vinyl imidazole; hyperbranched polyester amides; polyalkoxylated asphaltenes, amphoteric fatty acids; salts of alkyl succinates; sorbitan monooleate; and polyisobutylene succinic anhydride, or combinations thereof.

### Paraffin Inhibitors

The corrosion inhibitor composition disclosed herein can additionally include one or more paraffin inhibitors. Examples of paraffin inhibitors include, but are not limited to, paraffin crystal modifiers, and dispersant/crystal modifier combinations. Examples of paraffin crystal modifiers include, but are not limited to, alkyl acrylate copolymers, alkyl acrylate vinylpyridine copolymers, ethylene vinyl acetate copolymers, maleic anhydride ester copolymers, branched polyethylenes, naphthalene, anthracene, microcrystalline wax, asphaltenes, or combinations thereof. Examples of dispersants include, but are not limited to, dodecyl benzene sulfonate, oxyalkylated alkylphenols, and oxyalkylated alkylpnenolic resins, or combinations thereof.

### Scale Inhibitors

The corrosion inhibitor composition disclosed herein can additionally include one or more scale inhibitors. Examples of scale inhibitors include, but are not limited to, phosphates, phosphate esters, phosphoric acids, phosphonates, phosphonic acids, polyacrylamides, salts of acrylamido-methyl propane sulfonate/acrylic acid copolymer (AMPS/AA), phosphinated maleic copolymer (PHOS/MA), salts of a polymaleic acid/acrylic acid/acrylamido-methyl propane sulfonate terpolymer (PMA/AMPS), or combinations thereof.

### Emulsifiers

The corrosion inhibitor composition disclosed herein can additionally include one or more emulsifier. Examples of emulsifiers include, but are not limited to, salts of carboxylic acids, products of acylation reactions between carboxylic acids or carboxylic anhydrides and amines, alkyl-, acyl-, and amide derivatives of saccharides (alkyl-saccharide emulsifiers), or combinations thereof.

### Water Clarifiers

The corrosion inhibitor composition disclosed herein can include one or more water clarifiers. Examples of water clarifiers include, but are not limited to, inorganic metal salts such as alum, aluminum chloride, and aluminum chlorohydrate; organic polymers such as acrylic acid based polymers; acrylamide based polymers; polymerized amines; alkanolamines; thiocarbamates; cationic polymers such as diallyldimethylammonium chloride (DADMAC); or combinations thereof.

### Dispersants

The corrosion inhibitor composition can additionally include one or more dispersants. Examples of dispersants include, but are not limited to, aliphatic phosphonic acids with 2 to 50 carbon atoms (e.g., hydroxyethyl diphosphonic acid), aminoalkyl phosphonic acids (e.g. polyaminomethylene phosphonates with 2 to 10 N atoms, for example, each bearing at least one methylene phosphonic acid group), or combinations thereof. Examples of polyaminomethylene phosphonates are ethylenediamine tetra(methylene phosphonate), diethylenetriamine penta(methylene phosphonate), triamine- and tetramine-polymethylene phosphonates with 2-4 methylene groups between each N atom, at least 2 of the numbers of methylene groups in each phosphonate being different, or combinations thereof. Other dispersants can include lignin or derivatives of lignin such as lignosulfonate and naphthalene sulfonic acid and derivatives.

### Emulsion Breakers

The corrosion inhibitor composition can additionally include one or more emulsion breakers. Examples of emulsion breakers include, but are not limited to, dodecylbenzylsulfonic acid (DDBSA), the sodium salt of xylenesulfonic acid (NAXSA), epoxylated and propoxylated compounds, anionic cationic and nonionic surfactants, resins such as phenolic resins and epoxide resins, or combinations thereof.

### Hydrogen Sulfide Scavengers

The corrosion inhibitor composition can additionally include one or more hydrogen sulfide scavengers. Examples of additional hydrogen sulfide scavengers include, but are not limited to, oxidants (e.g., inorganic peroxides such as sodium peroxide, or chlorine dioxide), aldehydes (e.g., of 1 to 10 carbon atoms such as formaldehyde or glutaraldehyde or (meth)acrolein), triazines (e.g., monoethanol amine triazine, monomethylamine triazine, and triazines from multiple amines or mixtures thereof), glyoxal, or combinations thereof.

### Gas Hydrate Inhibitors

The corrosion inhibitor composition can additionally include one or more gas hydrate inhibitors. Examples of gas hydrate inhibitors include, but are not limited to, thermodynamic hydrate inhibitors (THI), kinetic hydrate inhibitors (KHI), anti-agglomerates (AA), or combinations thereof.

Examples of thermodynamic hydrate inhibitors include, but are not limited to, NaCl salt, KCl salt, CaCl₂ salt, MgCl₂ salt, NaBr₂ salt, formate brines (e.g. potassium formate), polyols (e.g., glucose, sucrose, fructose, maltose, lactose, gluconate, monoethylene glycol, diethylene glycol, triethylene glycol, mono-propylene glycol, dipropylene glycol, tripropylene glycols, tetrapropylene glycol, monobutylene glycol, dibutylene glycol, tributylene glycol, glycerol, diglycerol, triglycerol, sugar alcohols (e.g. sorbitol, mannitol), or combinations thereof), methanol, propanol, ethanol, glycol ethers (e.g., diethyleneglycol monomethylether, ethyleneglycol monobutylether, or combinations thereof), alkyl or cyclic esters of alcohols (e.g., ethyl lactate, butyl lactate, methylethyl benzoate, or combinations thereof), or combinations thereof.

Examples of kinetic hydrate inhibitors and anti-agglomerates include, but are not limited to, polymers and copolymers, polysaccharides (e.g., hydroxy-ethylcellulose (HEC), carboxymethylcellulose (CMC), starch, starch derivatives, xanthan, or combinations thereof), lactams (e.g., polyvinylcaprolactam, polyvinyl lactam), pyrrolidones (e.g., polyvinyl pyrrolidone of various molecular weights), surfactants (e.g., fatty acid salts, ethoxylated alcohols, propoxylated alcohols, sorbitan esters, ethoxylated sorbitan esters, polyglycerol esters of fatty acids, alkyl glucosides, alkyl polyglucosides, alkyl sulfates, alkyl sulfonates, alkyl ester sulfonates, alkyl aromatic sulfonates, alkyl betaine, alkyl amido betaines, or combinations thereof), hydrocarbon based dispersants (e.g., lignosulfonates, iminodisuccinates, polyaspartates, or combinations thereof), amino acids, proteins, or combinations thereof.

### Blocides

The corrosion inhibitor composition can additionally include one or more biocides.

Examples of biocides include, but are not limited to, oxidizing and non-oxidizing biocides. Examples of non-oxidizing biocides include, for example, aldehydes (e.g., formaldehyde, glutaraldehyde, acrolein, or combinations thereof), amine-type compounds (e.g., quaternary amine compounds, cocodiamine, or a combination thereof), halogenated compounds (e.g., bronopol, 2-2-dibromo-3-nitrilopropionamide (DBNPA), or a combination thereof), sulfur compounds (e.g., isothiazolone, carbamates, metronidazole, or a combination thereof), quaternary phosphonium salts (e.g., tetrakis(hydroxymethyl)phosphonium sulfate (THPS)), or combinations thereof.

Examples of oxidizing biocides include sodium hypochlorite, trichloroisocyanuric acids, dichloroisocyanuric acid, calcium hypochlorite, lithium hypochlorite, chlorinated hydantoins, stabilized sodium hypobromite, activated sodium bromide, brominated hydantoins, chlorine dioxide, ozone, peroxides, or combinations thereof.

### pH Modifiers

The corrosion inhibitor composition can additionally include one or more pH modifiers. Examples of pH modifiers include, but are not limited to, alkali hydroxides, alkali carbonates, alkali bicarbonates, alkaline earth metal hydroxides, alkaline earth metal carbonates, alkaline earth metal bicarbonates, or combinations thereof. Exemplary pH modifiers include NaOH, KOH, Ca(OH)₂, CaO, Na₂CO₃, KHCO₃, K₂CO₃, NaHCO₃, MgO, and Mg(OH)₂, or combinations thereof.

### Surfactants

The corrosion inhibitor composition can additionally include one or more surfactants.

Examples of surfactants include, but are not limited to, anionic surfactants, cationic surfactants, zwitterionic surfactants, and nonionic surfactants.

Anionic surfactants include alkyl aryl sulfonates, olefin sulfonates, paraffin sulfonates, alcohol sulfates, alcohol ether sulfates, alkyl carboxylates, alkyl ether carboxylates, alkyl phosphate esters, ethoxylated alkyl phosphate esters, and mono- and di-alkyl sulfosuccinates, mono- and di-alkyl sulfosuccinamates, or combinations thereof.

Cationic surfactants include alkyl trimethyl quaternary ammonium salts, alkyl dimethyl benzyl quaternary ammonium salts, dialkyl dimethyl quaternary ammonium salts, imidazolinium salts, or combinations thereof.

Nonionic surfactants include alcohol alkoxylates, alkylphenol alkoxylates, block copolymers of ethylene, propylene and butylene oxides, alkyl dimethyl amine oxides, alkyl-bis(2-hydroxyethyl) amine oxides, alkyl amidopropyl dimethyl amine oxides, alkylamidopropyl-bis(2-hydroxyethyl) amine oxides, alkyl polyglucosides, polyalkoxylated glycerides, sorbitan esters and polyalkoxylated sorbitan esters, alkyl polyethylene glycol esters and diesters, or combinations thereof. Examples of nonionic surfactants also include betaines, sultanes, amphoteric surfactants (e.g., alkyl amphoacetates and amphodiacetates, alkyl amphopropripionates and amphodipropionates, alkyliminodiproprionate, or combinations thereof), or combinations thereof.

In some aspect, a surfactant may be a quaternary ammonium compound, an amine oxide, an ionic or non-ionic surfactant, or any combination thereof. Suitable quaternary amine compounds include, but are not limited to, alkyl benzyl ammonium chloride, benzyl cocoalkyl(C₁₂-C₁₈)dimethylammonium chloride, dicocoalkyl (C₁₂-C₁₈)dimethylammonium chloride, ditallow dimethylammonium chloride, di(hydrogenated tallow alkyl)dimethyl quaternary ammonium methyl chloride, methyl bis(2-hydroxyethyl cocoalkyl(C₁₂-C₁₈) quaternary ammonium chloride, dimethyl(2-ethyl) tallow ammonium methyl sulfate, n-dodecylbenzyldimethylammonium chloride, n-octadecylbenzyldimethyl ammonium chloride, n-dodecyltrimethylammonium sulfate, soya alkyltrimethylammonium chloride, and hydrogenated tallow alkyl (2-ethylhyexyl) dimethyl quaternary ammonium methyl sulfate.

### Functional Agents and Other Additives

Corrosion inhibitor compositions may further include additional functional agents or additives that provide a beneficial property. For example, additional agents or additives may be selected from the group consisting of pH adjusters or other neutralizing agents, surfactants, emulsifiers, sequestrants, solubilizers, other lubricants, buffers, detergents, cleaning agent, rinse aid composition, secondary anti-corrosion agent, preservatives, binders, thickeners or other viscosity modifiers, processing aids, carriers, water-conditioning agents, foam inhibitors or foam generators, threshold agent or system, aesthetic enhancing agent (i.e., dye, odorant, perfume), other agents or additives suitable for formulation with a corrosion inhibitor composition and the like, and mixtures thereof. Additional agents or additives will vary according to the particular corrosion inhibitor composition being manufactured.

The corrosion inhibitor compositions made may further include additional functional agents or additives that provide a beneficial property. Additional agents or additives will vary according to the particular composition being manufactured and its intended use as one skilled in the art will appreciate. According to one embodiment, the compositions do not contain any of the additional agents or additives.

### Concentration of Additional Components

A corrosion inhibitor composition described herein may comprise from 0 wt % to 80 wt %, 0 wt % to 60 wt %, or 0 wt % to 50 wt % of one or more additional components, based on total weight of the composition. In some aspects, a corrosion inhibitor composition disclosed herein can have at least 1.0 wt %, 1.5 wt %, 2.0 wt %, 2.5 wt %, 3.0 wt %, 3.5 wt %, 4.0 wt %, 4.5 wt %, 5.0 wt %, 5.5 wt %, 6.0 wt %, 6.5 wt %, 7.0 wt %, 7.5 wt %, 8.0 wt %, 8.5 wt %, 9.0 wt %, 9.5 wt %, 10.0 wt %, 10.5 wt %, 11.0 wt %, 11.5 wt %, 12.0 wt %, 12.5 wt %, 13.0 wt %, 13.5 wt %, 14.0 wt %, 14.5 wt %, or 15.0 wt % of one or more additional components, based on total weight of the composition; and less than 80, 79, 78, 77, 76, 75, 74, 73, 72, 71, 70, 69, 68, 67, 66, 65, 64, 63, 62, 61, or 60 wt % of the one or more additional components based on total weight of the composition.

### Use and Methods

The corrosion inhibitor compositions can be used in any industry where it is desirable to inhibit corrosion on a metal surface. For example, the corrosion inhibitor compositions may be used for inhibiting corrosion on metal surfaces used in oil and gas applications, in water systems, in condensate/oil systems/gas systems, or any combination thereof.

A method can include preparing a corrosion inhibitor composition by mixing silica nanoparticles, a quaternary ammonium compound, an imidazoline derivative, and an organic sulfur compound. As disclosed herein, the silica nanoparticles can be non-functionalized, functionalized, or the silica nanoparticles can contain a first portion comprising functionalized silica nanoparticles and a second portion comprising non-functionalized silica nanoparticles.

Other methods can be performed after the corrosion inhibitor composition is prepared.

Another method can include contacting a fluid comprising the corrosion inhibitor composition disclosed herein with a metal surface.

Another method can include introducing, adding, or injecting the corrosion inhibitor composition into a fluid to inhibit corrosion on a metal surface that is in contact with the fluid.

Another method can include introducing, adding, or injecting the corrosion inhibitor composition into a fluid i) produced or used in the production, transportation, storage, and/or separation of crude oil or natural gas or ii) in a waste-water process, a farm, a slaughter house, a land-fill, a municipality waste-water plant, a coking coal process, or a biofuel process. In such methods, the method can additionally include producing, transporting, storing, or separating the fluid, prior to introducing, adding, or injecting the corrosion inhibitor composition into a fluid. Producing the fluid can include producing a production fluid from a wellbore formed in a subterranean formation.

Another method can include introducing, adding, or injecting the corrosion inhibitor composition to a gas stream used or produced in a coal-fired process, such as a coal-fired power plant.

Another method can include transporting or moving the fluid comprising the corrosion inhibitor composition in an oil and gas pipeline.

The fluid can comprise a hydrocarbon(s), water, or both (e.g., an aqueous medium).

The fluid can flow in a gas stream or in a liquid stream; alternatively, the fluid can be static in a vessel or flow through the vessel. In aspects where the fluid is an aqueous medium, the aqueous medium may comprise water, gas, and optionally liquid hydrocarbon(s).

In further aspects, the fluid can comprise liquid hydrocarbons. The liquid hydrocarbons can include, but are not limited to, crude oil, heavy oil, processed residual oil, bituminous oil, coker oils, coker gas oils, fluid catalytic cracker feeds, gas oil, naphtha, fluid catalytic cracking slurry, diesel fuel, fuel oil, jet fuel, gasoline, kerosene, or combinations thereof.

A temperature of the fluid can be from about 40° C. to about 250° C. In some aspects, the fluid may be at a temperature of from −50° C. to 300° C., 0° C. to 200° C., 10° C. to 100° C., or 20° C. to 90° C. In some aspects, the fluid may be at a temperature of 22° C., 23° C., 24° C., 25° C., 26° C., 27° C., 28° C., 29° C., 30° C., 31° C., 32° C., 33° C., 34° C., 35° C., 36° C., 37° C., 38° C., 39° C., or 40° C. In some aspects, the fluid may be at a temperature of 85° C., 86° C., 87° C., 88° C., 89° C., 90° C., 91° C., 92° C., 93° C., 94° C., 95° C., 96° C., 97° C., 98° C., 99° C., or 100° C.

The corrosion inhibitor compositions disclosed herein may be introduced, added, or injected to a fluid having water as part of the fluid. For example, the water concentration may be from 0% to 100% volume/volume (v/v), from 1% to 80% v/v, or from 1% to 60% v/v of the fluid. The fluid can be an aqueous medium that contains various levels of salinity.

In aspects, the fluid may have a low TDS, and the corrosion inhibitor composition can include functionalized silica nanoparticles, non-functionalized silica nanoparticles, or both functionalized silica nanoparticles and non-functionalized silica nanoparticles. In other aspects, the fluid may have a high TDS, and the corrosion inhibitor composition can include functionalized silica nanoparticles without including (does not include) non-functionalized silica nanoparticles.

In aspects, the fluid may be contained in or flow through many different types of apparatuses. In aspects, the apparatuses are downstream of the wellbore, relative to the direction of hydrocarbon flow from a subterranean formation. For example, the fluid may be contained in an apparatus that transports fluid from one location to another location, such as an oil pipeline, a gas pipeline, or an oil and gas pipeline. In certain aspects, the apparatus may be part of an oil and/or gas refinery, such as a pipeline or conduit, a separation vessel, a dehydration unit, or a gas line. The fluid may be contained in or flow through an apparatus used in oil extraction and/or production, such as a wellhead. In other aspects, the apparatus may be part of a coal-fired power plant. In yet other aspects, the apparatus may be a scrubber (e.g., a wet flue gas desulfurizer, a spray dry absorber, a dry sorbent injector, a spray tower, or a contact or bubble tower). In further aspects, the apparatus may be a cargo vessel, a storage vessel, a holding tank, or a pipeline connecting the tanks, vessels, or processing units. In some aspects, the fluid may be contained in water systems, condensate/oil systems/gas systems, or any combination thereof.

The corrosion inhibitor composition may be introduced, added, or injected into a fluid by any appropriate method for combining the corrosion inhibitor composition into the fluid. For example, the corrosion inhibitor composition can be added at a location in process flow that is upstream from the location at which corrosion prevention is desired. The corrosion inhibitor compositions may be injected using mechanical equipment such as a chemical injection pump, a piping tee, an injection fitting, an atomizer, an injection valve, or a quill. In some aspects, the corrosion inhibitor compositions may be pumped into an oil and/or gas pipeline using an umbilical line. In other aspects, capillary injection systems can be used to deliver the corrosion inhibitor compositions to a selected fluid.

In some aspects, the method can include, after introducing, adding, or injecting the corrosion inhibitor compositions to the fluid, mixing the fluid and corrosion inhibitor composition to disperse the corrosion inhibitor composition in the fluid.

In aspects, the corrosion inhibitor composition can be introduced, added, or injected into a fluid as an aqueous or nonaqueous solution, mixture, or slurry.

In aspects, the corrosion inhibitor compositions disclosed herein are typically added to a process flow line to provide an effective amount of the described corrosion inhibitor composition from about 0.01 to about 5,000 ppm based on a total weight of the fluid (e.g., gas, liquid, slurry, or combinations thereof) in the process flow line. In certain embodiments, the compositions may be added or introduced to a fluid to provide to provide an effective amount of the described corrosion inhibitor composition of from about 1 parts per million (ppm) to about 1,000,000 ppm; alternatively, from about 1 parts per million (ppm) to about 100,000 ppm; alternatively, from about 10 ppm to about 75,000 ppm; alternatively, from about 100 ppm to about 10,000 ppm; alternatively, from about 200 ppm to about 8,000 ppm; alternatively, from about 500 ppm to about 6,000 ppm; alternatively, about 0.1 ppm, 0.125 ppm, 0.25 ppm, 0.5 ppm, 0.625 ppm, 1 ppm, 1.25 ppm, 2 ppm, 2.5 ppm, 5 ppm, 10 ppm, 20 ppm, 100 ppm, 200 ppm, 500 ppm, or 1,000 ppm based on a total weight of the fluid.

In the method, the introduction, addition, or injection of the corrosion inhibitor compositions can include dosing the corrosion inhibitor compositions continuously, batch-wise, intermittent (periodically add a batch of corrosion inhibitor composition), or a combination thereof. Dosage concentration for continuous or intermittent dosing can range from about 10 ppm to about 500 ppm; alternatively, from about 10 ppm to about 200 ppm based on a total weight of the fluid. Dosage rates for batch dosing can range from about 10 ppm to about 400,000 ppm; alternatively, from about 10 to about 20,000 ppm based on a total weight of the fluid. In some aspects, the corrosion inhibitor composition can be added, introduced, or injected as a pill to a pipeline, providing a high dose (e.g., 20,000 ppm) of the corrosion inhibitor composition.

The flow rate of a process flow line in which the corrosion inhibitor composition is used may be in a range of from 0 to 100 feet per second, or in a range of from 0.1 to 50 feet per second. In some cases, the compositions may be formulated with water or with a solvent disclosed herein in order to facilitate addition to the flow line.

The corrosion inhibitor compositions disclosed herein may provide at least 80, 81, 82, 83, 84, 85, 86, 87, 88, 89, 90, 91, 92, 93, 94, 95, 96, 97, 98, or 99% corrosion protection for a metal surface, optionally as defined by a 1018 carbon steel coupon in a corrosion bubble cell test. A corrosion bubble cell test may be performed as described for the examples below. The corrosion bubble cell test is a test that compares the performance of one corrosion inhibitor to another, under a testing temperature of about 80° C., a CO₂ saturated fluid of 20 wt % LVT-200 oil and 80 wt % NaCl brine (aqueous 3 wt %), about 3 to 4 hours under conditions prior to composition injection, a test duration of about 15 hours, and a corrosion inhibitor composition dosage of 2 ppm based on water phase.

### EXAMPLES

The following examples are intended to illustrate different aspects and embodiments of the disclosed corrosion inhibitor and are not to be considered limiting. It will be recognized that various modifications and changes may be made to the experimental embodiments described herein, and without departing from the scope of the claims.

Six corrosion inhibitor compositions were tested for corrosion inhibition.

### Preparation of Corrosion Inhibitor Compositions 1 to 6

The corrosion inhibitor compositions were prepared by i) forming Blend 1, ii) forming Blend 2, and iii) mixing Blend 1 and Blend 2 with deionized water.

Forming Blend 1: Blend 1 of the corrosion inhibitor compositions was formed by mixing a) a solution of benzyl-(C₁₂-C₁₈ linear alkyl)-dimethyl ammonium chloride (the quaternary ammonium compound), b) a solution of acrylated TOFA-DETA imidazoline (the imidazoline derivative), and c) pure 2-mercaptoehtanol (the organic sulfur compound).

The solution of benzyl-(C₁₂-C₁₈ linear alkyl)-dimethyl ammonium chloride had an activity of 92 wt % based on a total weight of the solution. The solution of acrylated TOFA-DETA imidazoline had an activity of 80 wt % based on a total weight of the solution. 2-mercaptoehtanol was available in pure form, 100 wt %. These chemicals were mixed in the amounts in Table 1 below:

TABLE 1

| | Concentration in |
|---|---|
| Solution or Compound | Blend 1 (wt %) |
| solution of benzyl-(C₁₂-C₁₈ linear alkyl)- | 56 |
| dimethyl ammonium chloride | |
| solution of acrylated TOFA-DETA imidazoline | 35 |
| 2-mercaptoehtanol | 9 |
| Total | 100 |

The actual activities of each corrosion inhibitor component in Blend 1, considering the presence of solvents added with the solution of benzyl-(C₁₂-C₁₈ linear alkyl)-dimethyl ammonium chloride and the solution of acrylated TOFA-DETA imidazoline, are set forth in Table 2 below:

TABLE 2

| | Activity in |
|---|---|
| Compound | Blend 1 (wt %) |
| benzyl-( C₁₂-C₁₈ linear alkyl)- | 52 |
| dimethyl ammonium chloride | |
| acrylated TOFA-DETA imidazoline | 28 |
| 2-mercaptoehtanol | 9 |
| Total | 88 |

As can be seen, Blend 1 had an activity of 88 wt % for i) benzyl-(C₁₂-C₁₈ linear alkyl)-dimethyl ammonium chloride (the quaternary ammonium compound), ii) acrylated TOFA-DETA imidazoline (the imidazoline derivative), and iii) 2-mercaptoehtanol (the organic sulfur compound), based on a total weight of Blend 1.

Forming Blend 2: Blend 2 of the corrosion inhibitor compositions was formed by producing surface-modified silica nanoparticles in an aqueous solution. A dispersion of colloidal silica (Nalco 1130G, 30.11% actives, 7-9 nm, 330 m²/g) in water was charged to a reactor fitted with a stirrer, a condenser, and an additional funnel. Deionized (DI) water was added to adjust the final concentration of the silica nanoparticles (SNP) to 10-20% (w/v). The SNP and water were heated to 60° C. An aqueous solution of hydrolyzed epoxysilane (glycidyloxypropyltrimethoxy silane, also known as GPTMS) was added dropwise to the dispersion at 60° C. while mixing. The amount of GPTMS added was 10 μmol GPTMS per m² of the SNP surface. The reaction pH was maintained at 10, and the dispersion was stirred at 60° C. for 24 hours.

The resulting Blend 2 had 19 wt % functionalized silica nanoparticles based on a total weight of Blend 2.

Mixing Blend 1 and Blend 2 with deionized water Six corrosion inhibitor compositions were prepared by mixing six different combinations of Blend 1 and Blend 2 with deionized water.

Corrosion Inhibitor Composition 1 was formed by mixing Blend 1 (no Blend 2 included) with water, such that Corrosion Inhibitor Composition 1 contained 70 wt % Blend 1 and 30 wt % water. Corrosion Inhibitor Composition 1 had a total activity of 62 wt % for i) benzyl-(C₁₂-C₁₈ linear alkyl)-dimethyl ammonium chloride (the quaternary ammonium compound), ii) acrylated TOFA-DETA imidazoline (the imidazoline derivative), and iii) 2-mercaptoehtanol (the organic sulfur compound), based on a total weight of Corrosion Inhibitor Composition 1.

Corrosion Inhibitor Composition 2 was formed by mixing Blend 1 and Blend 2 with water, such that Corrosion Inhibitor Composition 2 contained 70 wt % Blend 1, 0.5 wt % Blend 2, and 29.5 wt % water.

Corrosion Inhibitor Composition 3 was formed by mixing Blend 1 and Blend 2 with water, such that Corrosion Inhibitor Composition 3 contained 70 wt % Blend 1, 1 wt % Blend 2, and 29 wt % water.

Corrosion Inhibitor Composition 4 was formed by mixing Blend 1 and Blend 2 with water, such that Corrosion Inhibitor Composition 4 contained 70 wt % Blend 1, 2 wt % Blend 2, and 28 wt % water.

Corrosion Inhibitor Composition 5 was formed by mixing Blend 1 and Blend 2 with water, such that Corrosion Inhibitor Composition 5 contained 70 wt % Blend 1, 4 wt % Blend 2, 26 wt % water.

Corrosion Inhibitor Composition 6 was formed by mixing Blend 1 and Blend 2 with water, such that Corrosion Inhibitor Composition 6 contained 70 wt % Blend 1, 16 wt % Blend 2, 14 wt % water.

Table 3 below sets forth the concentrations of the components in the Corrosion Inhibitor Compositions 1 to 6:

TABLE 3

| | Corrosion Inhibitor Composition | | | | | |
|---|---|---|---|---|---|---|
| | 1 | 2 | 3 | 4 | 5 | 6 |
| Functionalized Silica Nanoparticles | 0 | 0.095 | 0.19 | 0.38 | 0.76 | 3.04 |
| (wt %) | | | | | | |
| QAC + ID + OSC (wt %) | 61.6 | 61.6 | 61.6 | 61.6 | 61.6 | 61.6 |
| Weight Ratio of (QAC + ID + OSC): | n/a | 648 | 324 | 162 | 81 | 20 |
| Functionalized Silica Nanoparticles | | | | | | |

In Table 3 above, QAC=quaternary ammonium compound, ID=imidazoline derivative, and OSC=organic sulfur compound.

### Corrosion Inhibition Testing

The corrosion inhibition results of testing each of the Corrosion Inhibitor Compositions 1 to 6 is discussed below.

Corrosion bubble cell tests were performed using the following conditions to evaluate the corrosion inhibition performance of Corrosion Inhibitor Compositions 1 to 6 on a carbon steel electrode (C1018 grade): 80° C., CO₂ with saturated fluids with 3 wt % NaCl brine (80 wt % aqueous solution) and LVT-200 hydrocarbon (20%) with continuous CO₂ sparge, at atmospheric pressure. About 3 to 4 hours pre-corrosion time (i.e., with no corrosion inhibitor composition) was carried out before the corrosion inhibitor composition was injected.

The corrosion rate of each Corrosion Inhibitor Composition was assessed electrochemically using linear polarization resistance (LPR) methodology. The inhibited corrosion rate at about 15 hours after injection of each Corrosion Inhibitor Composition was determined by comparing the corrosion rate of each Corrosion Inhibitor Composition with the corrosion rate of a carbon steel electrode under otherwise same conditions in the absence of a corrosion inhibitor composition after the same time of exposure to the corrosive environment (referred to as the Blank).

Table 4 below shows parameters of the corrosion inhibition tests for Corrosion Inhibitor Compositions 1 to 6:

TABLE 4

| | | Corrosion Inhibitor Composition | | | | | |
|---|---|---|---|---|---|---|---|
| | Blank | 1 | 2 | 3 | 4 | 5 | 6 |
| Active Dose (ppmw) | n/a | 2 | 2 | 2 | 2 | 2 | 2 |
| Corrosion Rate after 15 hours of | 441 | 31 | 9 | 12 | 6 | 9 | 10 |
| Injection (mpy) | | | | | | | |
| Inhibited Corrosion Rate (%) | n/a | 93 | 98 | 97 | 99 | 98 | 98 |

Active dose in Table 4 above is the concentration of QAC, ID, OSC, and the functionalized silica nanoparticles. The inhibited corrosion rates for Corrosion Inhibitor Compositions 1 to 6 were calculated relative to the corrosion rate of the Blank, which was 441 mpy. All Corrosion Inhibitor Compositions 1 to 6 had lower corrosion rates than the Blank. It is noted that Corrosion Inhibitor Compositions 2 to 6, which had functionalized silica nanoparticles, had inhibited corrosion rates in range of 97% to 99%. In comparison, Corrosion Inhibitor Composition 1, which had no silica nanoparticles, had an inhibited corrosion rate of 93%. Testing of Corrosion Inhibitor Compositions 2 to 6 indicates that adding functionalized silica nanoparticles reduced corrosion rate by about 60% compared to testing of Corrosion Inhibitor Composition 1 (97-99% Inhibited Corrosion Rate for Corrosion Inhibitor Compositions 2-6 versus 93% inhibited Corrosion Rate for Corrosion Inhibitor Composition 1).

### Additional Description

Aspect 1. A method of inhibiting corrosion at a metal surface, the method comprising: contacting a fluid comprising a corrosion inhibitor composition with a metal surface, wherein the corrosion inhibitor composition comprises silica nanoparticles, a quaternary ammonium compound, an imidazoline derivative, and an organic sulfur compound.

Aspect 2. The method of Aspect 1, wherein the silica nanoparticles have an average particle size from 1 nm to 500 nm.

Aspect 3. The method of Aspect 1 or 2, wherein the silica nanoparticles are colloidal silica nanoparticles.

Aspect 4. The method of any one of Aspects 1 to 3, wherein the silica nanoparticles are present in an amount of from about 0.1 wt % to about 10 wt % based on a total weight of the corrosion inhibitor composition.

Aspect 5. The method of any one of Aspects 1 to 4, wherein a surface of the silica nanoparticles is bonded to an organosilane.

Aspect 6. The method of Aspect 5, wherein the organosilane comprises one or more one epoxy groups, vinyl groups, ether groups, styryl groups, methacryl groups, acryl groups, amino groups, isocyanurate groups, or combinations thereof.

Aspect 7. The method of Aspect 5, wherein the organosilane is an alkoxysilane, a silazane, a siloxane, or combinations thereof.

Aspect 8. The method of Aspect 5, wherein the organosilane comprises 3-glycidoxypropyltriethoxysilane, 3-glycidoxypropylmethyldimethoxysilane, 3-glycidoxypropylmethyldiethoxysilane, 3-glycidoxypropyltriethoxysilane, 2-(3,4-epoxycyclohexyl)propyltrimethoxysilane, 2-(3,4 epoxycyclohexyl)propyltriethoxysilane, 2-(3,4-epoxycyclohexyl)ethyltrimethoxysilane, 2-(3,4-epoxycyclohexyl)ethyltriethoxysilane, 2-(3,4-epoxycyclohexyl)methyltrimethoxysilane, 2-(3,4epoxycyclohexyl)methyltriethoxysilane, [(3-ethyl-3 oxethanyl)methoxy]propyltrimethoxysilane, [(3-ethyl-3-oxethanyl)methoxy]propyltriethoxysilane, or combinations thereof.

Aspect 9. The method of Aspect 5, wherein the organosilane is a zwitterionic silane.

Aspect 10. The method of Aspect 9, wherein the zwitterionic silane comprises 3-(dimethyl(3-(trimethoxysilyl)propyl)-ammonio) propane-1-sulfonate, 3-(dimethyl (3-(triethoxysilyl) propyl)-ammonio) propane-1-sulfonate, or 3-(diethyl (3-(trimethoxysilyl) propyl)-ammonio) propane-1-sulfonate.

Aspect 11. The method of any one of Aspects 5 to 10, wherein a mass ratio of the organosilane to the silica nanoparticles is 0.1:15.

Aspect 12. The method of any one of Aspects 1 to 11, wherein the quaternary ammonium compound is selected from tetramethyl ammonium chloride, tetraethyl ammonium chloride, tetrapropyl ammonium chloride, tetrabutyl ammonium chloride, tetrahexyl ammonium chloride, tetraoctyl ammonium chloride, benzyltimethyl ammonium chloride, benzyltriethyl ammonium chloride, phenyltrimethyl ammonium chloride, phenyltriethyl ammonium chloride, cetyl benzyldimethyl ammonium chloride, hexadecyl trimethyl ammonium chloride, dimethyl alkyl benzyl quaternary ammonium compounds, monomethyl dialkyl benzyl quaternary ammonium compounds, trimethyl benzyl quaternary ammonium compounds, trialkyl benzyl quaternary ammonium compounds, or combinations thereof.

Aspect 13. The method of any one of Aspects 1 to 11, wherein the quaternary ammonium compound is represented by the formula [N⁺R^{5a}R^{6a}R^{7a}R^{8a}][X⁻] wherein R^{5a}, R^{6a}, R^{7a}, and R^{8a} contain one to 18 carbon atoms, and X is Cl, Br or I.

Aspect 14. The method of any one of Aspects 1 to 11, wherein the quaternary ammonium compound is represented by the formula:

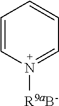

wherein R9a is an alkyl group, an aryl group, or an arylalkyl group, wherein the alkyl groups have from 1 to about 18 carbon atoms and B is CI, Br or I.

Aspect 15. The method of any one of Aspects 1 to 14, wherein the imidazoline derivative has a formula:

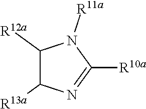

wherein R10a is a tall oil fatty acid (TOFA), and wherein R11a, R12a and R13a are each hydrogen.

Aspect 16. The method of any one of Aspects 1 to 15, wherein the organic sulfur compound comprises an organic disulfide compound or a thiol.

Aspect 17. The method of any one of Aspects 1 to 16, wherein the metal surface is a carbon steel.

Aspect 18. The method of any one of Aspects 1 to 17, wherein the fluid comprises water, a hydrocarbon, or combinations thereof.

Aspect 19. The method of any one of Aspects 1 to 18, wherein the metal surface is part of equipment used in a production, transportation, storage, and/or separation of crude oil or natural gas.

Aspect 20. The method of any one of Aspects 1 to 19, wherein the metal surface is part of equipment used in a coal-fired process, a waste-water process, a farm, a slaughter house, a land-fill, a municipality waste-water plant, a coking coal process, or a biofuel process.

Aspect 21. The method of any one of Aspects 1 to 20, wherein the silica nanoparticles do not form a chemical bond with the quaternary ammonium compound, the imidazoline derivative, the organic sulfur compound, or combinations thereof.

Aspect 22. The method of any one of Aspects 1 to 21, wherein the silica nanoparticles do not form a chemical bond with the quaternary ammonium compound(s), wherein the silica nanoparticles do not form a chemical bond with the imidazoline derivative(s), and wherein the silica nanoparticles do not form a chemical bond with the organic sulfur compound(s).

Aspect 23. The method of any one of Aspects 1 to 22, wherein a complex is formed between the silica nanoparticles and one or more of the quaternary ammonium compound, the imidazoline derivative, and the organic sulfur compound.

Aspect 24. The method of Aspect 23, wherein the complex contains no chemical bond between the silica nanoparticles and the one or more of the quaternary ammonium compound, the imidazoline derivative, and the organic sulfur compound.

Aspect 25. The method of Aspect 23 or 24, wherein the complex is formed by electrostatic interactions, van der Waals forces, or both, between the silica nanoparticles and one or more of the quaternary ammonium compound, the imidazoline derivative, and the organic sulfur compound.

Aspect 26. A corrosion inhibitor composition comprising: silica nanoparticles; a quaternary ammonium compound; an imidazoline derivative; and an organic sulfur compound, wherein the silica nanoparticles are present in an amount of from about 0.1 wt % to about 10 wt % based on a total weight of the corrosion inhibitor composition.

Aspect 27. The corrosion inhibitor composition of Aspect 26, wherein the silica nanoparticles have an average particle size from 1 nm to 500 nm.

Aspect 28. The corrosion inhibitor composition of Aspect 26 or 27, wherein the silica nanoparticles are colloidal silica nanoparticles.

Aspect 29. The corrosion inhibitor composition of anyone of Aspects 26 to 28, wherein a surface of the silica nanoparticles is bonded to an organosilane.

Aspect 30. The corrosion inhibitor composition of Aspect 29, wherein the organosilane comprises one or more one epoxy groups, vinyl groups, ether groups, styryl groups, methacryl groups, acryl groups, amino groups, isocyanurate groups, or combinations thereof.

Aspect 31. The corrosion inhibitor composition of Aspect 29 or 30, wherein the organosilane is an alkoxysilane, a silazane, a siloxane, or combinations thereof.

Aspect 32. The corrosion inhibitor composition of anyone of Aspects 29 to 31, wherein the organosilane comprises 3-glycidoxypropyltriethoxysilane, 3-glycidoxypropylmethyldimethoxysilane, 3-glycidoxypropylmethyldiethoxysilane, 3-glycidoxypropyltriethoxysilane, 2-(3,4-epoxycyclohexyl)propyltrimethoxysilane, 2-(3,4 epoxycyclohexyl)propyltriethoxysilane, 2-(3,4-epoxycyclohexyl)ethyltrimethoxysilane, 2-(3,4-epoxycyclohexyl)ethyltriethoxysilane, 2-(3,4-epoxycyclohexyl)methyltrimethoxysilane, 2-(3,4 epoxycyclohexyl)methyltriethoxysilane, [(3-ethyl-3 oxethanyl)methoxy]propyltrimethoxysilane, [(3-ethyl-3-oxethanyl)methoxy]propyltriethoxysilane, or combinations thereof.

Aspect 33. The corrosion inhibitor composition of anyone of Aspects 29 to 32, wherein the organosilane is a zwitterionic silane.

Aspect 34. The corrosion inhibitor composition of Aspect 33, wherein the zwitterionic silane comprises 3-(dimethyl(3-(trimethoxysilyl)propyl)-ammonio) propane-1-sulfonate, 3-(dimethyl (3-(triethoxysilyl) propyl)-ammonio) propane-1-sulfonate, or 3-(diethyl (3-(trimethoxysilyl) propyl)-ammonio) propane-1-sulfonate.

Aspect 35. The corrosion inhibitor composition of anyone of Aspects 29 to 34, wherein a mass ratio of the organosilane to the silica nanoparticles is 0.1:15.

Aspect 36. The corrosion inhibitor composition of anyone of Aspects 26 to 35, wherein the quaternary ammonium compound is selected from tetramethyl ammonium chloride, tetraethyl ammonium chloride, tetrapropyl ammonium chloride, tetrabutyl ammonium chloride, tetrahexyl ammonium chloride, tetraoctyl ammonium chloride, benzyltrimethyl ammonium chloride, benzyltriethyl ammonium chloride, phenyltrimethyl ammonium chloride, phenyltriethyl ammonium chloride, cetyl benzyldimethyl ammonium chloride, hexadecyl trimethyl ammonium chloride, dimethyl alkyl benzyl quaternary ammonium compounds, monomethyl dialkyl benzyl quaternary ammonium compounds, trimethyl benzyl quaternary ammonium compounds, trialkyl benzyl quaternary ammonium compounds, or combinations thereof.

Aspect 37. The corrosion inhibitor composition of anyone of Aspects 26 to 36, wherein the quaternary ammonium compound is represented by the formula [N⁺R^{5a}R^{6a}R^{7a}R^{8a}][X⁻] wherein R^{5a}, R^{6b}, R^{7a}, and R^{8a} contain one to 18 carbon atoms, and X is Cl, Br or I.

Aspect 38. The corrosion inhibitor composition of anyone of Aspects 26 to 37, wherein the quaternary ammonium compound is represented by the formula:

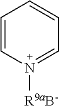

wherein R9a is an alkyl group, an aryl group, or an arylalkyl group, wherein the alkyl groups have from 1 to about 18 carbon atoms and B is Cl, Br or I.

Aspect 39. The corrosion inhibitor composition of anyone of Aspects 26 to 38, wherein the imidazoline derivative has a formula:

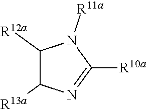

wherein R10a is a tall oil fatty acid (TOFA), and wherein R11a, R12a and R13a are each hydrogen.

Aspect 40. The corrosion inhibitor composition of anyone of Aspects 26 to 39, wherein the organic sulfur compound comprises an organic disulfide compound or a thiol.

Aspect 41. The corrosion inhibitor composition of anyone of Aspects 26 to 40, wherein no chemical bond is present between the silica nanoparticles and the quaternary ammonium compound, the imidazoline derivative, the organic sulfur compound, or combinations thereof.

Aspect 42. The corrosion inhibitor composition of anyone of Aspects 26 to 41, wherein no chemical bond is present between the silica nanoparticles and the quaternary ammonium compound, wherein no chemical bond is present between the silica nanoparticles and the imidazoline derivative, and wherein no chemical bond is present between the silica nanoparticles and the organic sulfur compound.

Aspect 43. The corrosion inhibitor composition of anyone of Aspects 26 to 42, wherein a complex is formed between the silica nanoparticles and one or more of the quaternary ammonium compound, the imidazoline derivative, and the organic sulfur compound.

Aspect 44. The corrosion inhibitor composition of Aspect 43, wherein the complex contains no chemical bond between the silica nanoparticles and the one or more of the quaternary ammonium compound, the imidazoline derivative, and the organic sulfur compound.

Aspect 45. The corrosion inhibitor composition of Aspect 43 or 44, wherein the complex is formed by electrostatic interactions, van der Waals forces, or both, between the silica nanoparticles and one or more of the quaternary ammonium compound, the imidazoline derivative, and the organic sulfur compound.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method of inhibiting corrosion at a metal surface, the method comprising:
contacting a fluid comprising a corrosion inhibitor composition with a metal surface,
wherein the corrosion inhibitor composition comprises silica nanoparticles, an imidazoline derivative, an oligomeric fatty acid, a nonionic surfactant, a sulfonic acid, and a solvent.

2. The method of claim 1, wherein the silica nanoparticles have an average particle size from 1 nm to 500 nm.

3. The method of claim 1, wherein the silica nanoparticles are colloidal silica nanoparticles.

4. The method of claim 1, wherein the silica nanoparticles are present in an amount of from about 0.1 wt % to about 1 wt % based on a total weight of the corrosion inhibitor composition.

5. The method of claim 1, wherein a surface of the silica nanoparticles is bonded to an organosilane, wherein the organosilane comprises one or more one epoxy groups, vinyl groups, ether groups, styryl groups, methacryl groups, acryl groups, amino groups, isocyanurate groups, or combinations thereof.

6. The method of claim 5, wherein a mass ratio of the organosilane to the silica nanoparticles is 0.1:15.

7. The method of claim 1, wherein the imidazoline derivative has a formula: 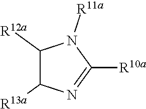
wherein R^{10a} is a tall oil fatty acid (TOFA), and
wherein R^{11a}, R^{12a} and R^{13a} are each hydrogen.

8. The method of claim 1, wherein the oligomeric fatty acid comprises a trimer of a C₁₄-C₂₂ saturated fatty acid.

9. The method of claim 1, wherein the nonionic surfactant comprises an alcohol alkoxylate.

10. The method of claim 1, wherein the sulfonic acid comprises dodecylbenzylsulfonic acid (DDBSA).

11. The method of claim 1, wherein the solvent comprises a heavy aromatic naphtha.

12. The method of claim 1, wherein the corrosion inhibitor composition is present in an amount of from 1 ppm to 100,000 ppm based on a total weight of the fluid.

13. The method of claim 1, wherein the fluid comprises water, a hydrocarbon, or combinations thereof; wherein the metal surface is carbon steel and is part of equipment used in a production, transportation, storage, and/or separation of crude oil or natural gas or is part of equipment used in a coal-fired process, a waste-water process, a farm, a slaughter house, a land-fill, a municipality waste-water plant, a coking coal process, or a biofuel process.

14. A corrosion inhibitor composition comprising:
silica nanoparticles;
an imidazoline derivative;
a nonionic surfactant;
an oligomeric fatty acid;
a sulfonic acid; and
a solvent,
wherein the silica nanoparticles are present in an amount of from about 0.1 wt % to about 1 wt % based on a total weight of the corrosion inhibitor composition.

15. The corrosion inhibitor composition of claim 14, wherein the imidazoline derivative has a formula: 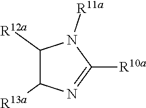
wherein R^{10a} is a tall oil fatty acid (TOFA), and
wherein R^{11a}, R^{12a} and R^{13a} are each hydrogen.

16. The corrosion inhibitor composition of claim 14, wherein the oligomeric fatty acid comprises a trimer of a C₁₄-C₂₂ saturated fatty acid.

17. The corrosion inhibitor composition of claim 14, wherein the nonionic surfactant comprises an alcohol alkoxylate.

18. The corrosion inhibitor composition of claim 14, wherein the sulfonic acid comprises dodecylbenzylsulfonic acid (DDBSA).

19. The corrosion inhibitor composition of claim 14, wherein the solvent comprises a heavy aromatic naphtha.

20. A fluid comprising:
the corrosion inhibitor composition of claim 14; and
water, a hydrocarbon, or combinations thereof,
wherein the corrosion inhibitor composition is present in an amount of from 1 ppm to 100,000 ppm based on a total weight of the fluid.
